(19) United States
(12) Patent Application Publication
(10) Pub. No.: US 2007/0165111 A1
(43) Pub. Date: Jul. 19, 2007

(54) Visual presenter

(75) Inventors: Kazuhiro Sukenari, Nagoya (JP); Hiroshi Yamakose, Gifu (JP); Yoshihiko Araya, Kariya (JP); Tetsuro Kato, Nagoya (JP)

Correspondence Address: KODA & ANDROLIA, 2029 CENTURY PARK EAST, SUITE 1140, LOS ANGELES, CA, 90067, US

(73) Assignee: Elmo Co., Ltd.

(21) Appl. No.: 11/439,332

(22) Filed: May 22, 2006

(30) Foreign Application Priority Data
Jan. 19, 2006 (JP) 2006-010782

(51) Int. Cl. H04N 9/04; H04N 5/225

(52) U.S. Cl. 348/207.99

(57) ABSTRACT

A visual presenter includes a base including a pivotal shaft support, a support column standing on the pivotal shaft support and having a distal end curved so as to protrude in such a direction that the distal end becomes more distant from the base, and an imaging camera rotatably mounted on the distal end of the support column. The imaging camera includes a casing having both lengthwise ends, an imaging camera body mounted on one lengthwise end of the casing and an operation unit mounted on the other lengthwise end. The pivotal shaft support is biased from a lengthwise center of the casing relative to the support column so that a distance from the support column to the one lengthwise end of the casing on which the imaging camera is mounted is longer than a distance from the support column to the other lengthwise end of the casing.

### CROSS-REFERENCE TO RELATED APPLICATIONS

This application is based upon and claims the benefit of priority from the prior Japanese Patent Application No. 2006-010782, filed on Jan. 19, 2006, the entire contents of which are incorporated herein by reference.

### BACKGROUND OF THE INVENTION

1. Field of the Invention

The present invention relates to a visual presenter which displays on a monitor, screen or the like a captured image of material.

2. Description of the Related Art

Conventional visual presenters include an image input device comprising a base which supports a support column standing thereon and has a distal end on which a camera is mounted and a pair of foldable legs. JP-H08-111803 discloses one of such image input devices. The legs are foldable along the support column, and the legs and support column are detachable from the base, so that the portability of the device can be improved.

Furthermore, JP-H10-191105 discloses an image input device comprising two supporting members having ends provided with joints which are connected together thereby to constitute a support. The support has a distal end on which a camera head is rotatably mounted. A hinge constituting each joint is provided with a plurality of indexes so that the camera head assumes a position suitable for manuscript of a specific one of fixed sizes. When both hinges are set at the same index, the camera head can be adjusted to a suitable height.

In the image input device disclosed by JP-H08-111803, however, the detached support column and legs need to be re-attached to the base and the folded legs need to be unfolded in use of the device. Thus, the image input device has a low level of operability and usability. Furthermore, in the image input device disclosed by JP-H10-191105, two hinges need to be set at the same index so that the camera head is adjusted to a suitable height. As a result, the image input device has a low level of operability. Additionally, a plurality of joints complicate the structure of the image input device.

### SUMMARY OF THE INVENTION

Therefore, an object of the present invention is to provide a visual presenter which can prevent audience's sightlines to a presenter from being interrupted and provide improved operability.

The present invention provides a visual presenter comprising a visual presenter comprising a base including a pivotal shaft support, a support column standing on the pivotal shaft support of the base and having a distal end which is curved so as to protrude in such a direction that said distal end becomes more distant from the base, and an imaging camera rotatably mounted on the distal end of the support column, the imaging camera including a casing having both lengthwise ends, an imaging camera body mounted on one lengthwise end of the casing and an operation unit mounted on the other lengthwise end of the casing. The pivotal shaft support is biased from a lengthwise center of the casing relative to the support column so that a distance from the support column to said one lengthwise end of the casing on which the imaging camera is mounted is longer than a distance from the support column to said other lengthwise end of the casing.

According to the above-described construction, the body of the imaging camera is mounted on one of lengthwise ends of the casing of the imaging camera, and the operation unit of the imaging camera is mounted on the other lengthwise end. Accordingly, an operation such as focusing, zooming or the like can be carried out at the end of the imaging camera. Since the operator need not reach for an operation panel mounted on a base as in conventional visual presenter, the operability of the visual presenter can be improved. Furthermore, since the pivot shaft support is biased from the lengthwise center of the casing relative to the support column so that the distance to the one lengthwise end of the. casing on which the imaging camera is mounted is longer than the distance to the other lengthwise end of the casing. Consequently, when the imaging camera assuming the horizontal position is rotated into a vertical position with the camera body side being lowered, sightlines of audience to a presenter are not interrupted when the device is not in use. Consequently, eye contact can be allowed between a teacher and students in an in-class lecture employing the visual presenter.

In one embodiment, the support column is inclinable in such a direction that said distal end thereof becomes more distant from the base. Accordingly, when the imaging camera assuming the horizontal position is rotated into a vertical position with the camera body side being lowered and then inclined, no portions protrude rightward and leftward. Consequently, an accommodating characteristic of the visual presenter can be improved.

In another embodiment, the casing is lengthwise divided a plurality of parts, which further comprises a coupling shaft extending lengthwise and coupling the parts to each other for relative rotation. Consequently, an imaging direction can be selected according to the position of the imaging camera, and the operation for adjustment such as focusing, zooming and the like can be carried out at the other end of the imaging camera, whereupon the operability can be prevented from being reduced.

### BRIEF DESCRIPTION OF THE DRAWINGS

Other objects, features and advantages of the present invention will become clear upon reviewing the following description of the embodiment with reference to the accompanying drawings, in which:

FIG. 1 is a perspective view of a visual presenter in accordance with one embodiment of the present invention;

FIG. 2 is an exploded perspective view of a pivot shaft;

FIG. 3 is a sectional view of the pivot shaft;

FIG. 4 is a perspective view of the pivot shaft;

FIG. 5 is a perspective view of an imaging camera;

FIG. 6 is a perspective view of an interior of the imaging camera;

FIG. 7 is a perspective view of another example of the imaging camera;

FIG. 8 is a perspective view of the body of the visual presenter when the imaging camera is in a horizontal position;

FIG. 9 is also a perspective view of the body of the visual presenter when the imaging camera is in a vertical position;

FIG. 10 is further a perspective view of the body;

FIG. 11 is a perspective view of a positioner and a positioned member;

FIG. 12 is a perspective view of the stage;

FIG. 13 is a perspective view of the stage;

FIG. 14 is a perspective view of the stage; and

FIG. 15 is a perspective view of the stage.

### DETAILED DESCRIPTION OF THE INVENTION

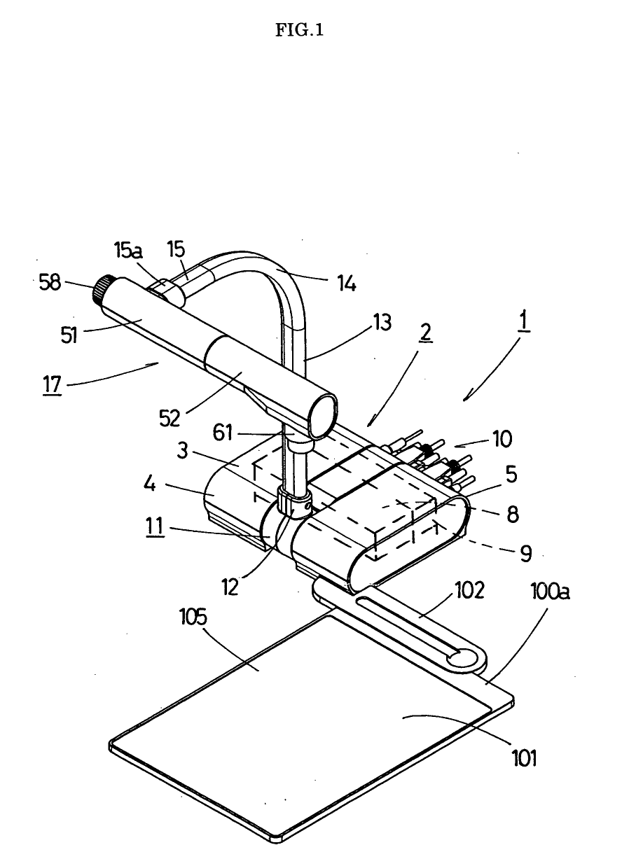

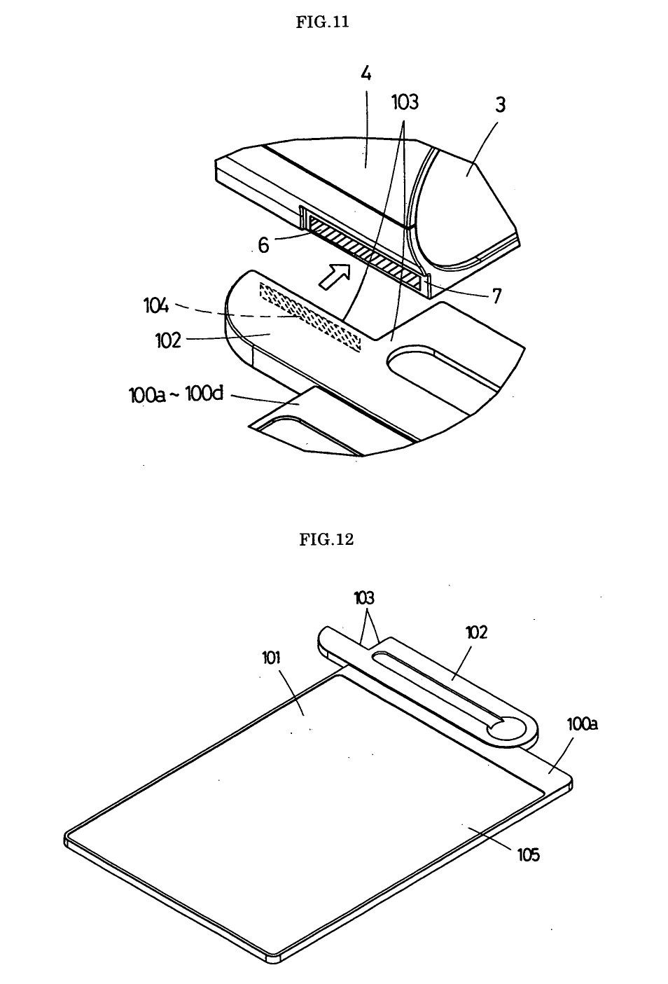

One embodiment of the present invention will be described with reference to the accompanying drawings. Referring to FIG. 1, a visual presenter 1 of the embodiment is shown. The visual presenter 1 comprises a body 2 and a stage 100a coupled to the body 2. The body 2 includes a base 3, a support column 13 and an imaging camera 17. The base 3 is formed into a rectangular shape and has a front 4 and a rear 5 both of which have curved faces. A positioner 7 is formed in a corner of a lower edge of the front 4 as shown in FIG. 11. The positioner 7 includes a magnet piece 6 affixed thereto.

A control circuit unit 8 and a weight 9 are enclosed in the base 3. The weight 9 prevents the rear 5 side of the base 3 from rising when the support column 13 is inclined frontward. Furthermore, various connecting sockets 10 and the like are provided on the rear 5 of the base 3 for ensuring electrical connection between external equipment and the visual presenter 1. A pivot shaft 11 is pivotally mounted on substantially a central part of the curved surface 4 side of the base 3. The pivot shaft 11 has an upper surface on which a support column mounting portion 12 is formed.

The support column 13 is inserted into the mounting portion 12 so as to stand. The support column 13 is hollow and accordingly, wire harness (not shown) is inserted through the support column 13. A curved portion 14 is formed on the support column 13. The curved portion 14 has a distal end on which a horizontal portion 15 protruding in such a direction that the horizontal portion 15 is spaced away from the front 4 of the base 3. Furthermore, the horizontal portion 15 has a distal end on which a coupling part 15a is mounted. The coupling part 15a also has a distal end on which a hollow pivot shaft 16 formed. An imaging camera 17 is pivotally mounted on the hollow pivot shaft 16.

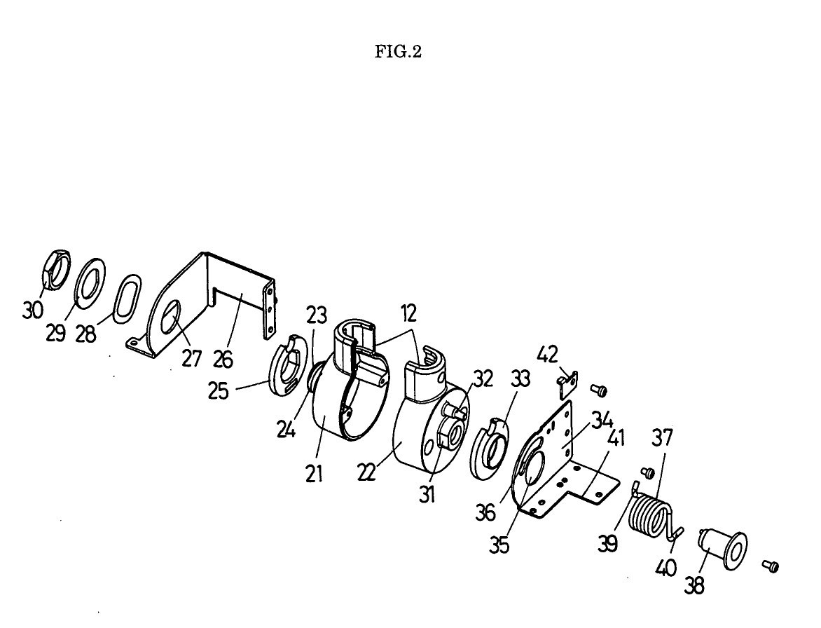

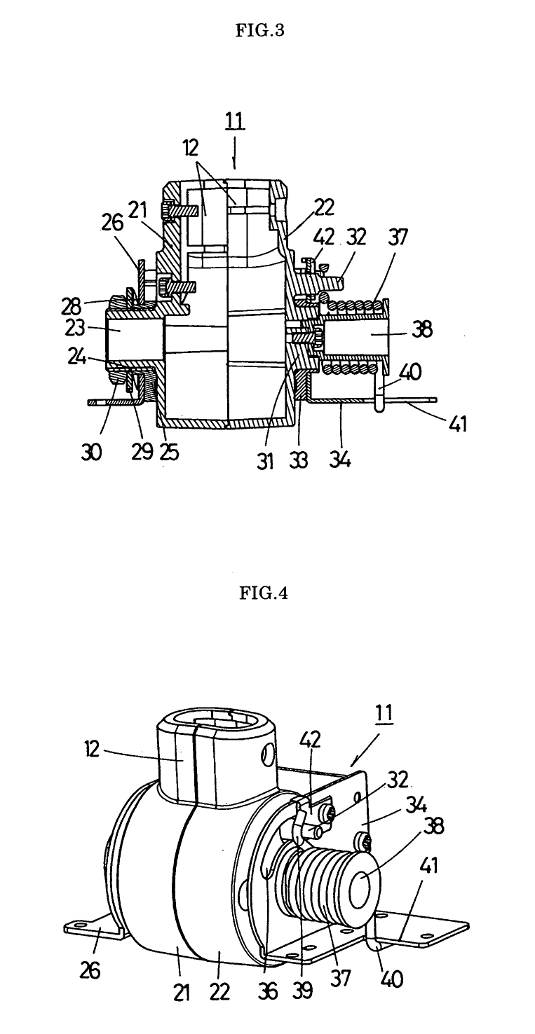

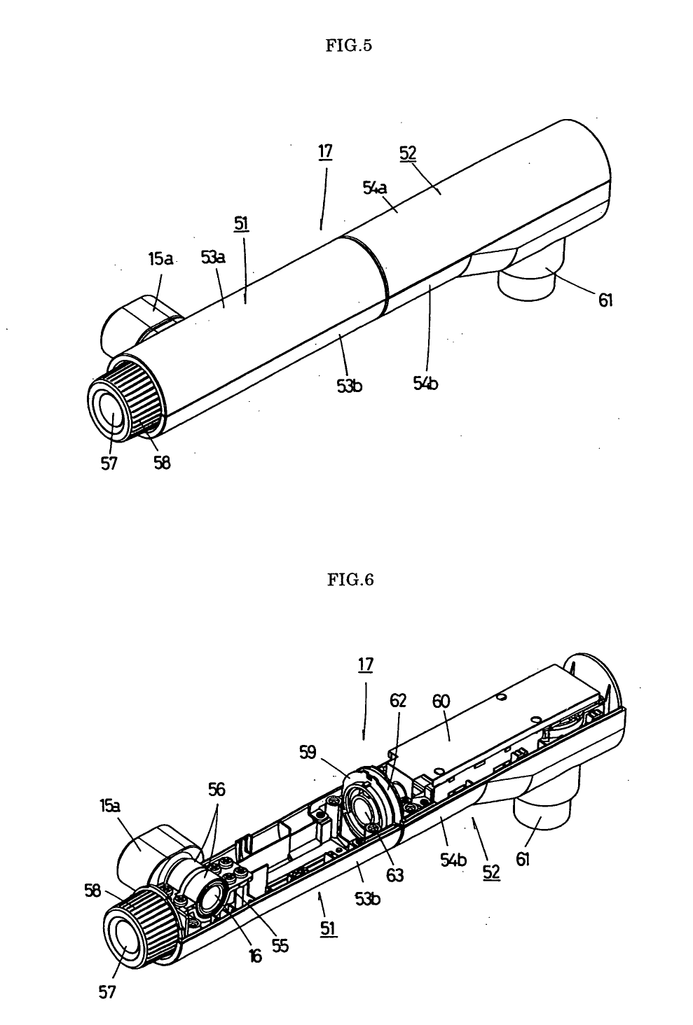

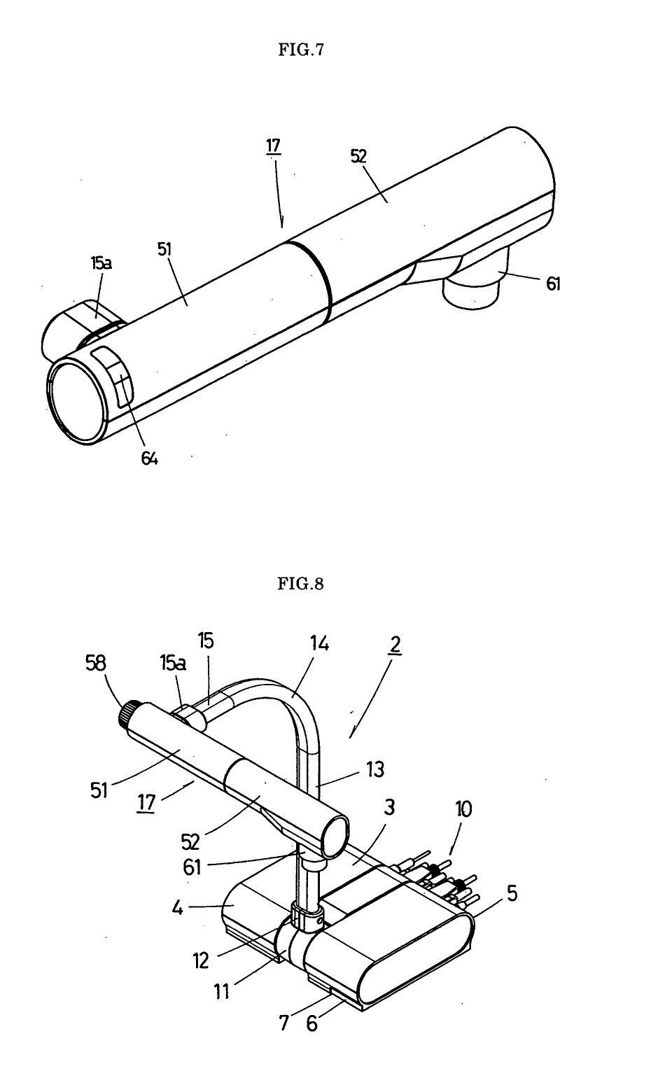

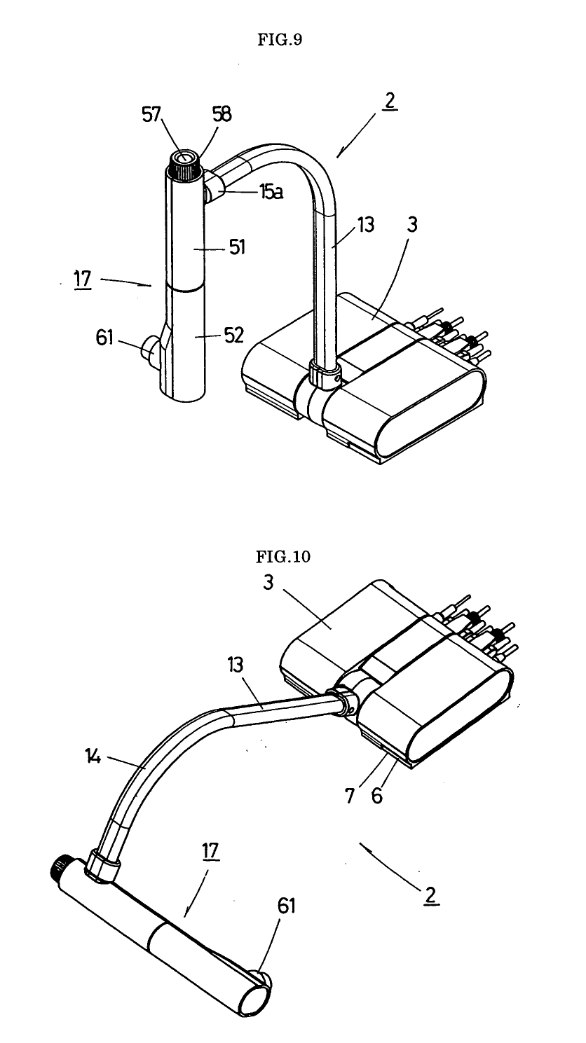

Referring now to FIGS. 2 to 4, the pivot shaft 11 includes two left and right members 21 and 22 integrated together. The members 21 and 22 are made from aluminum by die-casting. The left member 21 is formed with a hollow shaft 23. The hollow shaft 23 has a distal end on which a male screw 24 is formed. The hollow shaft 23 is inserted through a operation unit hole 27 of the bracket 26 fixed in the base 3 with a spacer 25 being fitted on the male thread 24. A corrugated washer 28 and a flat washer 29 are fitted on a part of the hollow shaft protruding from the shaft support hole 27. The corrugated washer 28 and a flat washer 29 are tightened up against the bracket 26 by a nut 30.

A right-hand member 22 includes a shaft 31 and a spring-holding pin 32 both formed on a right sidewall thereof, as shown in FIG. 2. The shaft 31 is inserted through a shaft hole 35 of a bracket 34 fixed in the base 3 with a spacer 33 being interposed therebetween. The spring-holding pin 32 is inserted through an arc hole 36 formed in the bracket 34 so as to be concentric with the shaft hole 35. The shaft 31 has an end to which a shaft 38 with a return spring 37 is fixed.

The return spring 37 has one end formed with a hook 39 hooked on the pin 32 and the other end also formed with a hook 40 which is hooked on a spring hook 41 of the bracket 34. The return spring 37 imparts a turning force on the support column 13 standing on the mounting portion 12 in such a direction that the support column 13 rises from a forwardly-leaning position. The bracket 34 is provided with a stopper 42 controlling the rising state of the support column 13 against which the pin 32 abuts.

Referring now to FIG. 5, an imaging camera 17 comprises two parts obtained by dividing the camera at a lengthwise center thereof, that is, a slender operation unit 51 and a camera body 52. The operation unit 51 includes upper and lower two-split cylindrical cases 53a and 53b both made of a synthetic resin. The camera body 52 also includes upper and lower two-split cylindrical cases 54a and 54b both made of a synthetic resin.

A pivot shaft 16 is mounted on a distal end of the horizontal part 15 of the support column 13. The pivot shaft 16 is inserted into a hole (not shown) formed in a proximal end of the lower case 53b. The pivot shaft 16 is pivotally mounted on a pivot bearing 55 by a clamping piece 56 screwed to the bearing 55 provided on the case 53b. A stopper (not shown) is provided case 53b for limiting a pivoting angle of the pivot shaft 16 to 90 degrees. A detent mechanism (not shown) is provided between the case 53b and the pivot shaft 16 for offering a crisp feel at every 90-degree pivot. A zoom dial 58 with a centrally incorporated autofocus button is rotatably mounted on a proximal end of the case 53b. A coupling shaft bracket 59 is mounted on a side end opposite to the zoom dial 58.

A camera control circuit unit 60 for the imaging camera 17 is mounted on the lower case 54b of the camera body 52. A lens barrel 61 is formed on a lower distal end of the case 53b so as to protrude. A coupling shaft bracket 62 is mounted on the proximal end of the case 54b. A hollow coupling shaft 63 is inserted between the bracket 59 of the case 53b and the bracket 62 of the case 54b. The camera body 52 is pivotally coupled to the operation unit 51 by the coupling shaft 63. The imaging camera 17 may comprise an operation knob 64 or the like, instead of the zoom dial 58.

The control circuit unit 8 disposed in the base 3, the camera control circuit unit 60 and the zoom dial 58 with incorporated autofocus button 57 and the like are electrically connected to one another. A wire harness ensuring the electrical connection is arranged through the hollow shaft 23 of the pivot shaft 11, the support column 13, the hollow pivot shaft 16 and the coupling shaft 63. The above-described body 2 is caused to pivot about the pivot shaft 16 of the pivot operation unit 51 of the imaging camera 17 from the steady state as shown in FIGS. 1 and 8, so that the body 2 can be changed from the horizontal state to the vertical state and to the state where the column 13 is leaned forward.

When the column 13 is leaned forward, the weight 9 disposed in the base 3 prevents the rear 5 side of the base 3 from rising. Furthermore, a nut 30 applies a braking force via the washers 28 and 29 to the pivot shaft 11 between the brackets 26 and 34. Additionally, the return spring 37 biases the shaft 31 of the pivot shaft 11 in such a direction that the forwardly leaned support column 13 rises. Accordingly, when pivoting moment of the column 13 with the imaging camera 17 mounted thereon, the clamping force of the nut 30 and a biasing force of the return spring 37 are adjusted so as to become head-to-head or substantially equal to one another, the support column 13 can be stopped at any forward lean angle, that is, a free stop mechanism can be provided. Furthermore, when the column 13 is returned from the forward leaning state to the rising state, the column 13 can easily be caused to rise with assistance of the biasing force of the return spring 37.

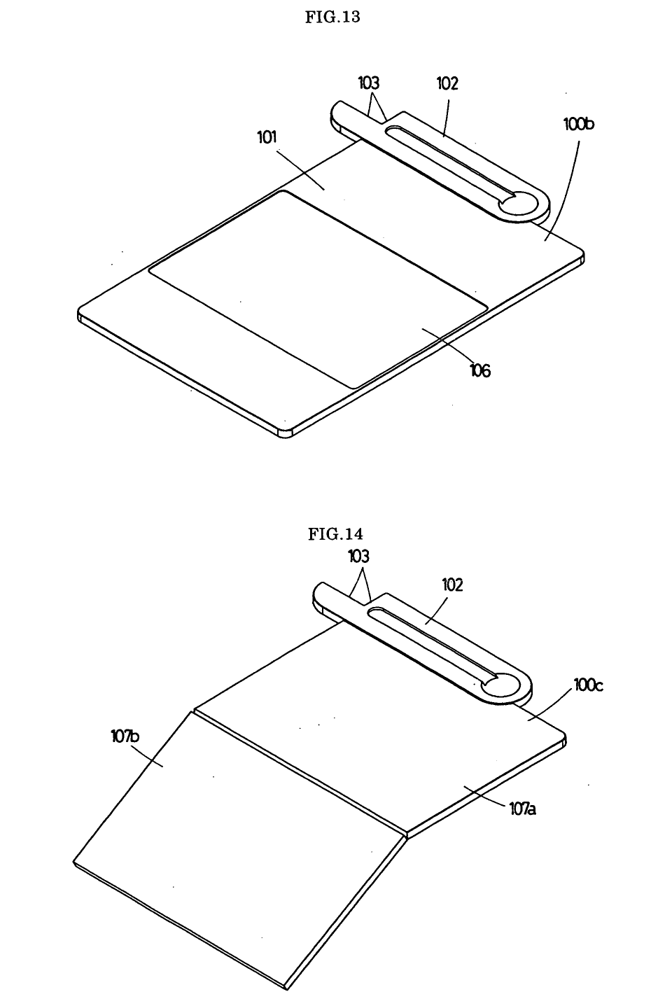

FIGS. 12 to 15 exemplify stages 100a to 100d coupled to the body 2 in use. Each stage has an upper surface or placement surface 101. Furthermore, each stage has a front edge formed with a positioned member 102 coupled to the positioner 7 of the base 3. The positioned member 102 is formed with a right-angled estimation portion 103 which has one side on which a magnetic piece 104 is affixed.

The aforesaid positioner 7 and the positioned member 102 are coupled together by an attractive force of the magnet. In this case, the right-angled corner of the base 3 abuts against the estimation portion 103 so that the placement surfaces 101 of the stages 100a to 100d are positioned so as to correspond to an imaging range of the imaging camera 17 in the normal state of the body 2 and so that a central part of the placement surface 101 corresponds to a central part of the imaging range of the imaging camera 17.

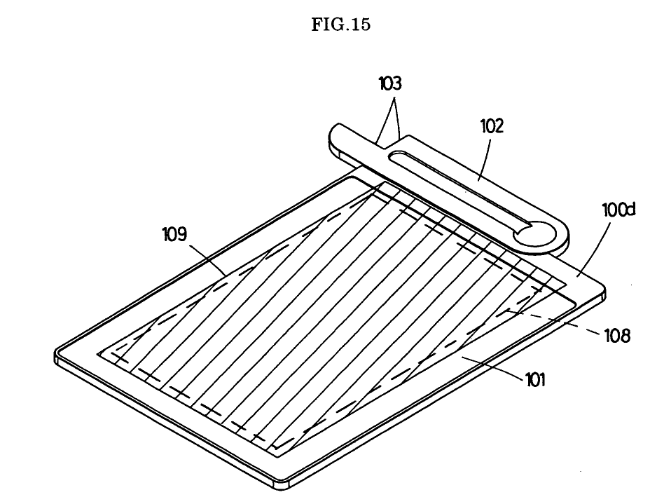

The stage 100a as shown in FIG. 12 includes a whiteboard 105 serving as the placement surface 101. The stage 100b as shown in FIG. 13 has a backlight illumination 106 provided on the placement surface 101. The stage 100c as shown in FIG. 14 includes stage members 107a and 107b connected to each other by hinges (not shown). The stage 100d as shown in FIG. 15 is used in the case where a shine material 108 is to be presented. In this case, an attached antireflective sheet 109 is covered.

The coupling of the positioner 7 and the positioned member 102 may be executed by fitting of a protrusion of the dovetail tenon type in a dovetail groove which are coupled together in the relation of male and female. Furthermore, the positioned member 102 may be attachable to and detachable from each of the stages 100a to 100d, whereupon a single positioned member can commonly be used.

According to the above-described visual presenter 1, the casing of the imaging camera 17 is divided at a substantially lengthwise center thereof. The body of the imaging camera is mounted on one end of the casing thereby to serve as the imaging camera body 52. The operation unit 51 including the zoom dial 58 for adjusting the imaging camera and the like is mounted on the other end of the casing. Accordingly, an operation such as focusing, zooming or the like can be carried out at the end of the imaging camera 17. Since the operator need not reach for an operation panel mounted on a base as in conventional visual presenter, the operability of the visual presenter can be improved. Furthermore, since the pivot bearing 55 is formed on the proximal end of the operation unit 51, the distance to the end at the imaging camera body 52 side is longer than the distance to the other end where the operation unit 51 is mounted. Accordingly, when the imaging camera 17 assuming the horizontal position is rotated into a vertical position with the camera body 51 side being lowered, audience's sightlines to a presenter are not interrupted. Consequently, eye contact can be allowed between a teacher and students in an in-class lecture employing the visual presenter.

Furthermore, the support column 13 is inclinable in such a direction that the distal end thereof becomes more distant from the base 3. Accordingly, when the imaging camera 17 assuming the horizontal position is rotated into a vertical position with the camera body 51 side being lowered and then inclined, no portions protrude rightward and leftward. Consequently, an accommodating characteristic of the visual presenter can be improved.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

We claim:

1. A visual presenter comprising:
a base including a pivotal shaft support;
a support column standing on the pivotal shaft support of the base and having a distal end which is curved so as to protrude in such a direction that said distal end becomes more distant from the base; and
an imaging camera rotatably mounted on the distal end of the support column, the imaging camera including a casing having both lengthwise ends, an imaging camera body mounted on one lengthwise end of the casing and an operation unit mounted on the other lengthwise end of the casing, wherein the pivotal shaft support is biased from a lengthwise center of the casing relative to the support column so that a distance from the support column to said one lengthwise end of the casing on which the imaging camera is mounted is longer than a distance from the support column to said other lengthwise end of the casing.

2. The visual presenter according to claim 1, wherein the support column is inclinable in such a direction that said distal end thereof becomes more distant from the base.

3. The visual presenter according to claim 1 or 2, wherein the casing is lengthwise divided a plurality of parts, which further comprises a coupling shaft extending lengthwise and coupling the parts to each other for relative rotation.
